(19) United States
(12) Patent Application Publication
(10) Pub. No.: US 2014/0178598 A1
(43) Pub. Date: Jun. 26, 2014

(54) METHOD FOR FORMING GRAPHENE PATTERN

(71) Applicant: ELECTRONICS AND TELECOMMUNICATIONS RESEARCH INSTITUTE, Daejeon (KR)

(72) Inventors: Kwang Hyo CHUNG, Daejeon (KR); Jin Tae KIM, Daejeon (KR); Young-Jun YU, Daejeon (KR); Jin Sik CHOI, Daejeon (KR); Doo Hyeb YOUN, Daejeon (KR); Ki-Chul KIM, Daejeon (KR); Choon Gi CHOI, Daejeon (KR)

(21) Appl. No.: 13/916,404

(22) Filed: Jun. 12, 2013

(30) Foreign Application Priority Data
Dec. 24, 2012 (KR) 10-2012-0152407

(51) Int. Cl. B05D 7/24

(52) U.S. Cl. CPC B05D 7/24
USPC 427/535; 427/275

(57) ABSTRACT

Disclosed are methods for forming a graphene pattern. The method includes forming a fine pattern defined by at least one trench on a substrate, applying a graphene solution on the fine pattern, and selectively forming a graphene layer on the fine pattern contacting the graphene solution.

### CROSS-REFERENCE TO RELATED APPLICATIONS

This U.S. non-provisional patent application claims priority under 35 U.S.C. §119 to Korean Patent Application No. 10-2012-0152407, filed on Dec. 24, 2012, the entirety of which is incorporated by reference herein.

### BACKGROUND

The inventive concept relates to methods for forming a fine pattern and, more particularly, to methods for forming a graphene pattern.

A graphene may be applied to various electronic devices and electrodes. Thus, various techniques for forming a graphene on a substrate have been suggested. For example, a technique using a chemical vapor deposition (CVD) method and a technique using graphene oxide (GO) and reduced graphene oxide (RGO) have been suggested for realizing large area electronic devices and electrodes. The technique for forming the graphene on the substrate may include a technique of growing a graphene layer on the substrate, and a patterning technique for forming a fine pattern functioning as an element of the electronic device. To achieve this, various methods have been suggested.

In an example, a metal (e.g., nickel or copper) is deposited on a SiO₂ substrate and then the deposited metal is patterned. The graphene is grown on a top surface of the patterned metal. Thus, the graphene has a patterned shape due to the patterned metal. The patterned graphene may be transferred on a second substrate by using a flexible material such as polydimethylsiloxane (PDMS). Alternatively, the SiO₂ layer and the patterned metal under the patterned graphene are etched, such that the patterned graphene floating on an etching solution may be transferred on the second substrate. In this case, for a structural stability of the floating graphene, the SiO₂ layer and the patterned metal may be etched after a supporting layer (e.g., polymethyl methacrylate (PMMA)) is formed on the graphene.

In another example, the graphene may be grown on a substrate having a deposited metal (e.g., nickel or copper) or on a nickel or copper thin layer by a CVD process, and a stamp may be manufactured to have a trench structure. The stamp may be formed of a flexible material such as polydimethylsiloxane (PDMS). The graphene may be transferred on a second substrate by using the stamp. The transferred graphene has the shape corresponding to the trench structure of the stamp. Alternatively, graphene oxide or a graphene plate may be coated on the substrate and then may be transferred using the stamp onto the second substrate.

In still another example, the graphene may be grown or transferred on a final substrate and then may be directly patterned using a photolithography process and an etching process. Alternatively, the graphene on the final substrate may be patterned using a laser beam.

In even another example, the patterned graphene may be directly formed on the final substrate by an inkjet printing method using dispersed GO particles or RGO particles.

In yet another example, after a molecular layer (e.g., a self-assembled monolayer) may be patterned on a substrate by a micro contact printing process or a dip-pen nanolithography process, the substrate may be immersed in a dispersed graphene solution so that the graphene may be adsorbed on only the patterned molecular layer.

As described above, various graphene patterning methods have been developed. However, the aforementioned methods may be complex. Additionally, the etching solution, a photoresist, PMMA, or PDMS may be used in the methods to cause a remaining contamination source. Moreover, the transferred substrate may be limited. Furthermore, there may be limitations in the process techniques for forming fine patterns. Thus, various researches have been conducted for a method for forming a fine graphene pattern on a large area substrate by simplified processes.

### SUMMARY

Embodiments of the inventive concept may provide method for forming a graphene pattern capable of increasing productivity

In an aspect, a method for forming a graphene pattern includes: forming a fine pattern defined by at least one trench on a substrate; providing a graphene solution on the fine pattern; and selectively forming a graphene layer on the fine pattern contacting the graphene solution.

In an embodiment, the graphene solution may become selectively in contact with a top surface of the fine pattern by a Cassie-Baxter state. The Cassie-Baxter state may mean that the graphene solution does not permeate into the trench but selectively remains on the top surface of the fine pattern.

In an embodiment, the method may further include: removing the graphene solution after forming the graphene layer. The graphene solution may be removed by a passive method using evaporation or dryness, or by an active method using turning force, inertial force, gravity, or gas flowing force.

In an embodiment, the graphene solution may be applied by a spraying method, a spin coating method, or a printing method.

In an embodiment, the graphene solution may include a solvent and graphene oxide or reduced graphene oxide dissolved in the solvent. The solvent may include at least one of organic and inorganic solvents including water, phosphate buffered saline (PBS), glycerol, ethanol, methanol, acetone, hexane, and benzene.

In an embodiment, the graphene layer may include graphene oxide or reduced graphene oxide. If the graphene layer includes the graphene oxide, the method may further include: converting the graphene oxide into reduced graphene oxide.

In an embodiment, the substrate may include a plastic, an organic film, silicon, or glass.

In an embodiment, the fine pattern may be formed by an injection molding process, a hot embossing process, a nano-imprint process, a casting process, a rolling process, a forging process, and/or a semiconductor process.

In an embodiment, the method may further include: performing a surface treating process on the substrate having the fine pattern. The surface treating process may include a plasma-treating process using oxygen and/or carbon fluoride.

In an embodiment, applying the graphene solution may include: dipping the substrate in the graphene solution.

In an embodiment, the method may further include: placing the substrate into a container. The container may include a housing or package surrounding the substrate.

In an embodiment, the method may further include: forming a self-assembled layer on the fine pattern. The self-assembled layer may be a monolayer. The monolayer may include at least one of a thiol group, a silane group, a carboxyl group, a hydroxyl group, a methyl group, a phosphonate group, and an amine group.

### BRIEF DESCRIPTION OF THE DRAWINGS

The inventive concept will become more apparent in view of the attached drawings and accompanying detailed description.

FIGS. 1 to 3 are cross-sectional views illustrating a method for forming a graphene pattern according to a first embodiment of the inventive concept;

FIG. 4 is an enlarged view of a fine pattern and a trench of FIG. 1;

FIG. 5 is a cross-sectional view illustrating a method for forming a graphene pattern according to a second embodiment of the inventive concept;

FIGS. 6 to 9 are cross-sectional views illustrating a method for forming a graphene pattern according to a third embodiment of the inventive concept; and

FIGS. 10 to 12 are cross-sectional views illustrating a method for forming a graphene pattern according to a fourth embodiment of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

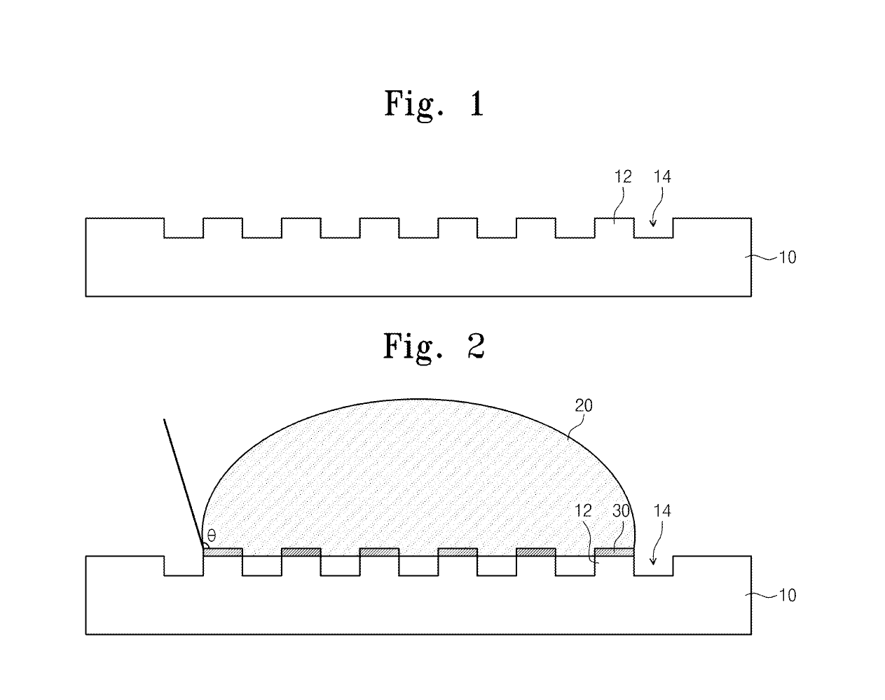

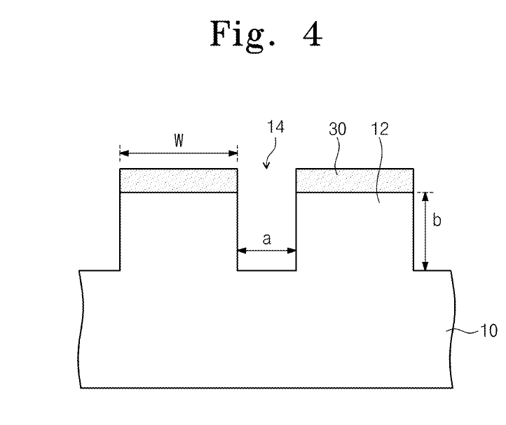

FIGS. 1 to 3 are cross-sectional views illustrating a method for forming a graphene pattern according to a first embodiment of the inventive concept. FIG. 4 is an enlarged view of a fine pattern 12 and a trench 14 of FIG. 1.

Referring to FIGS. 1 and 4, fine patterns 12 are formed on a substrate 10. The substrate 10 may include a plastic, an organic film, silicon, or glass. The fine patterns 12 may be formed by an injection molding process, a hot embossing process, a nano-imprint process, a casting process, a rolling process, a forging process, and/or a semiconductor process. The fine patterns 12 may be embossed by trenches 14. In other words, the trenches 14 may define the embossed fine patterns 12. For example, the trench 13 may have a width a of about 10 nm to about 100 μm and a depth b of about 10 nm to about 100 μm. Even not shown in the drawings, a surface of the substrate 10 may be treated by a plasma-treating process using oxygen and/or carbon fluoride after the formation of the fine patterns 12.

Referring to FIGS. 2 and 4, a graphene solution 20 is applied to the substrate 10. The graphene solution 20 may include a solvent and graphene oxide or reduced graphene oxide dissolved in the solvent. An applying degree of the graphene solution 20 may be determined depending on a surface state of the substrate 10 and a viscosity and a surface tension of the solvent. The solvent may include at least one of various organic and inorganic solvents such as water, phosphate buffered saline (PBS), glycerol, ethanol, methanol, acetone, hexane, and benzene. The graphene oxide may be converted into graphene by a reductant. The reductant may include hydrazine, sodium boro-hydride (NaBH₄), or hydro-iodide (HI). The graphene solution 20 may be applied by a spin coating method, a spraying method, or a printing method. An upper surface of the fine pattern 12 may be selectively in contact with the graphene solution 20. The graphene solution 20 may have a Cassie-Baxter state on the substrate 10. The Cassie-Baxter state may mean that the graphene solution 20 does not permeate into the trenches 14 but selectively remains on the fine patterns 12. The graphene solution 20 may agglomerate to have a droplet-shape. Here, the graphene solution 20 having the droplet-shape may satisfy the following equation 1 (i.e., Young's equation)

γ_{SL}−γ_{S}+γ_{L} COS θ=0 [Equation 1]

In the equation 1, ‘θ’ denotes a contact angle of the graphene solution 20, and ‘γ_{L}’ denotes a surface tension of the graphene solution 20. Additionally, ‘γₛ’ denotes a surface tension of the substrate 10, and ‘γ_{SL}’ denotes an interfacial tension of the graphene solution 20 and the substrate 10 in the equation 1. According to the equation 1, the contact angle θ may be determined by the surface tension γ_{L} of the graphene solution 20, the surface tension γₛ of the substrate 10, and the interfacial tension γ_{SL} of the graphene solution 20 and the substrate 10. In other words, the contact angle θ may be determined depending on a kind of the substrate 10 and a kind of the graphene solution 20.

As described above, the graphene solution 20 may have the Cassie-Baxter state on the substrate having the trenches 14 and the fine patterns 12. Thus, the graphene solution 20 may agglomerate to have the droplet-shape. In the Cassie-Baxter state, a contact angle θ_{CB} of the graphene solution 20 may increase. This may be expressed by the following equation 2.

COS θ_{CB}=φ(COS θ+1)−1 [Equation 2]

In the equation 2, ‘φ’ denotes an area ratio of a surface of the substrate 10 contacting the graphene solution 20, ‘θ’ denotes a contact angle of the graphene solution when the substrate is flat, and ‘θ_{CB}’ denotes the contact angle of the graphene solution 20 increased by the Cassie-Baxter state. The Cassie-Baxter state and the contact angle of the graphene solution 20 may be determined according to the width a and the depth b of the trench 14. Here, a value by dividing the depth b by the width a is defined as an aspect ratio. For realizing the Cassie-Baxter state, the solvent of the graphene solution 20 may have a great surface tension, and the substrate 10 may be formed of a material having a low interfacial energy in order to hardly get wet with the graphene solution 20. A graphene layer 30 may be adsorbed on the top surface of each of the fine patterns 12 from the graphene solution 20.

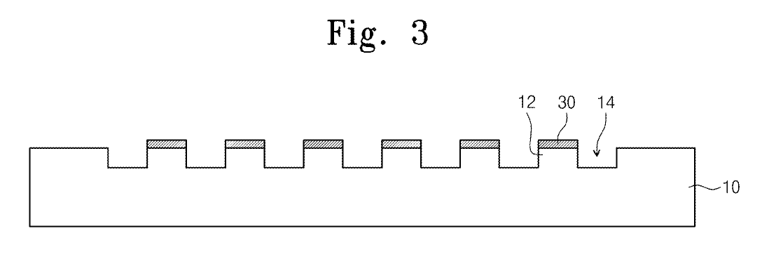

Referring to FIG. 4, the top surface of the fine pattern 12 may be flat, and the trench 14 may have a cross section of a quadrilateral shape. If the fine patterns 12 are formed by the injection molding process, the cross section of the trench 14 may be formed to have a diamond shape for easy deformation of the fin patterns 12. Thus, the shape of the trench 14 should be determined in due consideration of the formation of the Cassie-Baxter state and the deformation of the injection molding process. In other words, if the aspect ratio (b/a) is great, the injection molding process may be difficult. On the contrary, if the aspect ratio is small, the formation of the Cassie-Baxter state may be difficult. Thus, the aspect ratio may increase within a range capable of performing the injection molding process. If a general plastic injection molding process is used, the aspect ratio may be within a range of about 0.5 to about 2. The width of the fin pattern 12 may be varied without a size limit to control a width of the finely patterned graphene layer 30. Referring to FIG. 3, the graphene solution 20 may be removed from the fine patterns 12. The solvent of the graphene solution 20 may be removed by a passive method using evaporation or dryness, or an active method using turning force, inertial force, gravity, or gas flowing force. At this time, the graphene layer 30 may remain on the top surface of the fine pattern 12. The graphene layer 30 may be annealed by a thermal treatment. As a result, the graphene layer 30 may be easily formed on the substrate 10 having a large area.

Thus, the method for forming the graphene pattern according to the first embodiment may improve productivity.

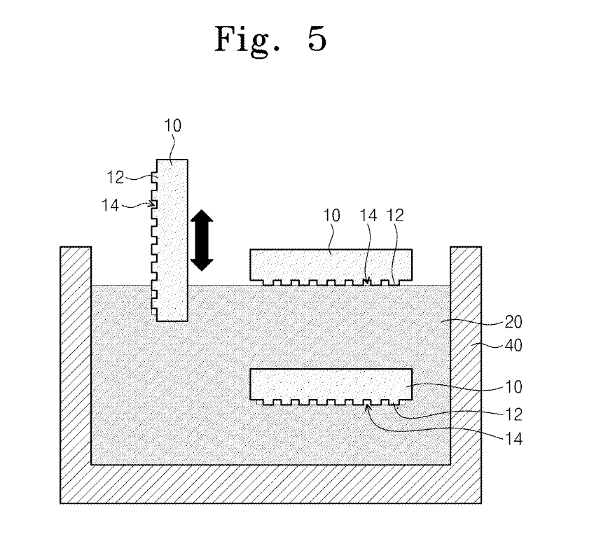

FIG. 5 is a cross-sectional view illustrating a method for forming a graphene pattern according to a second embodiment of the inventive concept.

Referring to FIGS. 1 and 5, the fine patterns 12 may be formed on the substrate 10, and then the substrate 10 may be immersed in a graphene solution 20. The graphene solution 20 may be stored in a chemical bath 40. The chemical bath 40 may include an inner space having a diameter and a depth that are greater than a length of the substrate 10. In an embodiment, the substrate 10 may dip into the graphene solution 20. The substrate 10 may dip into the graphene solution 20 in a direction perpendicular, inclined or parallel to the graphene solution 20. The dipping process and a drying process of the substrate 10 may be repeatedly performed. Alternatively, the substrate 10 may be continuously disposed within the graphene solution 20 for a predetermined time. The graphene solution 20 may have the Cassie-Baxter state on the substrate 10. As described above, the graphene solution 20 of the Cassie-Baxter state may not permeate into the trenches 14 and may be in contact with only the top surfaces of the fine patterns 12. The trench 14 may be filled with air like a bubble within the graphene solution 20. In another embodiment, the substrate 10 may be floated on the graphene solution 20. The top surfaces of the fine patterns 12 may be locally in contact with the graphene solution 20. The graphene solution 20 may not permeate into the trenches 14. Thus, the graphene solution 20 may be disposed to have the Cassie-Baxter state on the substrate 10.

Referring to FIG. 2, the substrate 10 may be taken out of the chemical bath 40. The graphene solution 20 may remain in a droplet-shape of the Cassie-Baxter state on the fine patterns 12 of the substrate 10.

Referring to FIG. 3, the solvent of the graphene solution 20 may be removed to form the graphene layer 30 on the fine pattern 12. The graphene layer 30 may be adsorbed on the fine pattern 12 before the removal of the graphene solution 20.

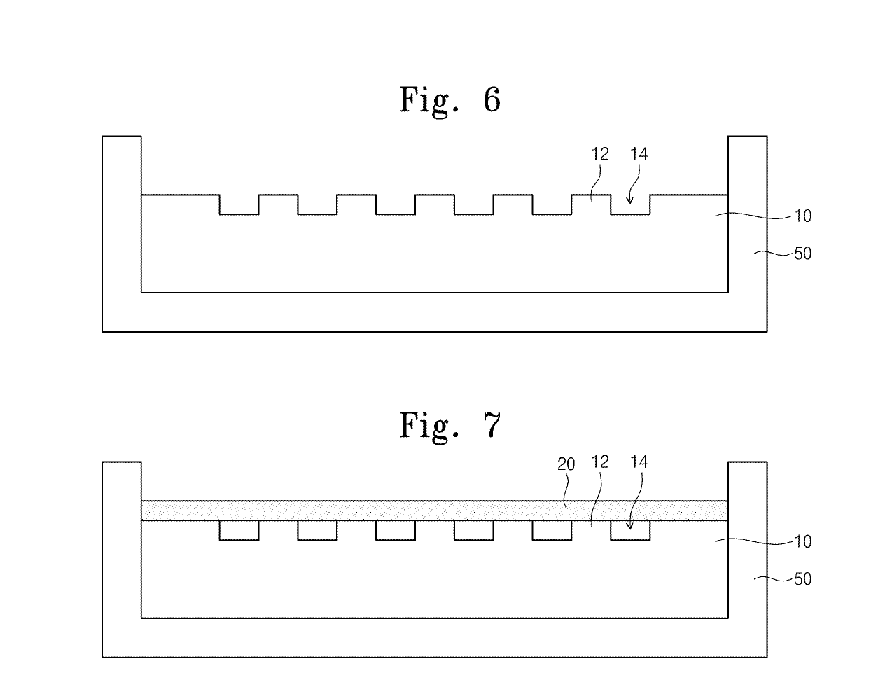

FIGS. 6 to 9 are cross-sectional views illustrating a method for forming a graphene pattern according to a third embodiment of the inventive concept.

Referring to FIGS. 1 and 6, the fine patterns 12 may be formed on the substrate 10 and then the substrate 10 may be placed into a container 50. The substrate 10 may be disposed safely on a bottom of the container 50. The container 50 may have an inner area substantially equal to an area of the substrate 10. The substrate 10 may be inserted into the container 50. The container 50 may surround the substrate 10, and the fine patterns 12 may be exposed through an upper region of the container 50. For example, the container 50 may include a housing or a package.

Referring to FIG. 7, the graphene solution 20 may be applied to the substrate 10 in the container 50. The container 50 may restrict the graphene solution 20 on the substrate 10. The graphene solution 20 may drop on the substrate 10 until the graphene solution 20 has a horizontal surface in the container 50.

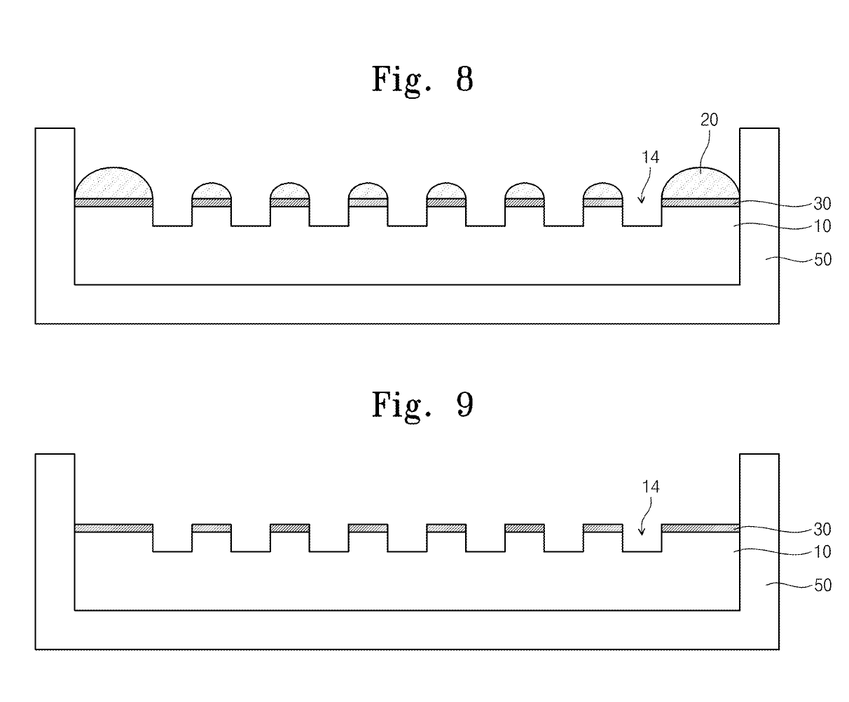

Referring to FIG. 8, the graphene solution 20 may agglomerate in the Cassie-Baxter state on the fine pattern 12 of the substrate 10. The graphene solution 20 may have a droplet-shape on the fine pattern 12. A plurality of the droplets of the graphene solution 20 may be disposed on a plurality of the fine patterns 12, respectively.

Referring to FIG. 9, the graphene solution 20 may be removed, such that a graphene layer 30 may be formed on each of the fine patterns 12. The graphene solution 20 may be removed by a passive method using evaporation or dryness, or an active method using turning force, inertial force, gravity, or gas flowing force. Next, the substrate 10 may be separated from the container 50.

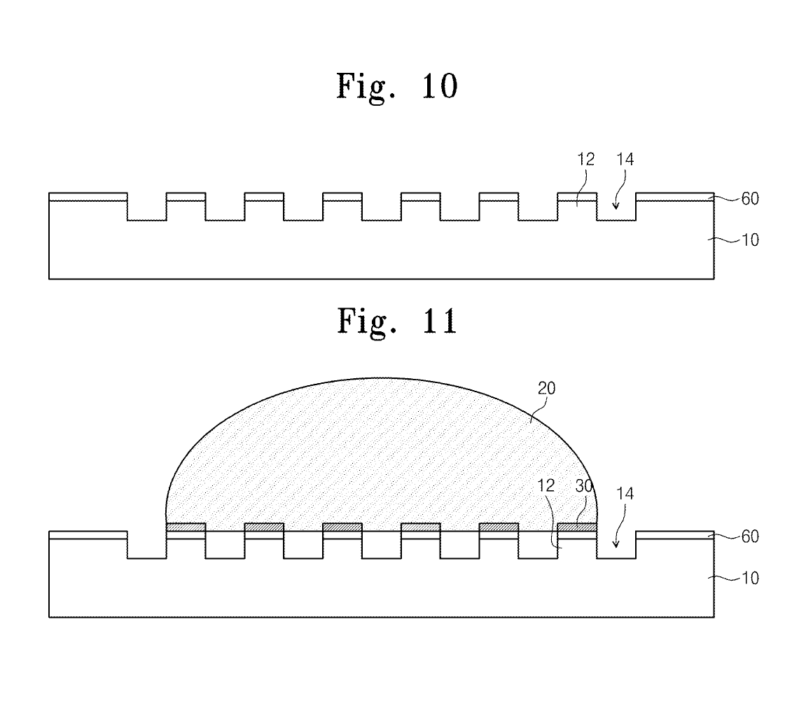

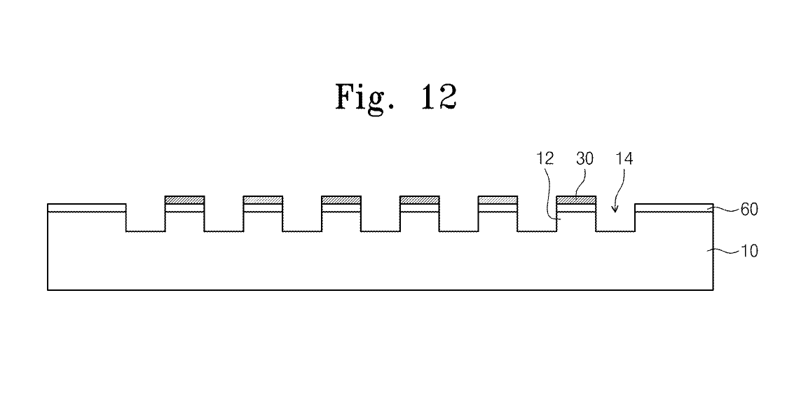

FIGS. 10 to 12 are cross-sectional views illustrating a method for forming a graphene pattern according to a fourth embodiment of the inventive concept.

Referring to FIGS. 1 and 10, the fine patterns 12 may be formed on the substrate 10 and then a self-assembled layer 60 may be formed on each of the fine patterns 12. The self-assembled layer 60 may be a monolayer. Thus, the self-assembled layer 60 may be called ‘a self-assembled monolayer’. The self-assembled layer 60 may include at least one of chemical components such as a thiol group, a silane group, a carboxyl group, a hydroxyl group, a methyl group, a phosphonate group, and an amine group. Even though not shown in the drawings, the self-assembled layer 60 may be formed by floating the substrate 10 on a chemical component or by immersing the substrate 10 in the chemical component. At this time, the chemical component may have the Cassie-Baxter state on the fine patterns 12 of the substrate 10.

Referring to FIG. 11, a graphene solution 20 may be applied to the self-assembled layer 60. The graphene solution 20 may have the Cassie-Baxter state on the self-assembled layer 60. Here, the Cassie-Baxter state means that the graphene solution 20 does not permeate into the trench 14 and sidewalls of the self-assembled layer 60 and the fine pattern 12. The graphene layer 30 may be adsorbed on the self-assembled layer 60 in the graphene solution 20.

Referring to 12, the graphene solution 20 remaining on the fine pattern 12 may be removed. As described above, the solvent of the graphene solution 20 may be removed by the passive method using evaporation or dryness, or the active method using turning force, inertial force, gravity, or gas flowing force. Thus, the graphene layer 30 may be selectively and easily formed on the self-assembled layer 60 and the fine pattern 12.

As a result, the method for forming the graphene pattern according to the fourth embodiment may improve productivity.

According to embodiments of the inventive concept, the fine pattern is formed on the substrate and then the graphene solution of the Cassie-Baxter state is formed on the fine pattern. The fine pattern may be formed by the injection molding process, the hot embossing process, the nano-imprint process, the casting process, the rolling process, the forging process, and/or the semiconductor process. The solvent of the graphene solution may be removed to selectively form the graphene layer on the fine pattern. Thus, the graphene layer may be easily formed on the large area substrate. As a result, the methods for forming the graphene pattern according to the embodiments may improve the productivity.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A method for forming a graphene pattern comprising:
forming a fine pattern defined by at least one trench on a substrate;
providing a graphene solution on the fine pattern; and
selectively forming a graphene layer on the fine pattern contacting the graphene solution.

2. The method of claim 1, wherein the graphene solution becomes selectively in contact with a top surface of the fine pattern by a Cassie-Baxter state.

3. The method of claim 2, wherein the Cassie-Baxter state means that the graphene solution does not permeate into the trench but selectively remains on the top surface of the fine pattern.

4. The method of claim 3, further comprising:
removing the graphene solution after forming the graphene layer.

5. The method of claim 4, wherein the graphene solution is removed by a passive method using evaporation or dryness, or by an active method using turning force, inertial force, gravity, or gas flowing force.

6. The method of claim 1, wherein the graphene solution is applied by a spraying method, a spin coating method, or a printing method.

7. The method of claim 1, wherein the graphene solution includes a solvent and graphene oxide or reduced graphene oxide dissolved in the solvent.

8. The method of claim 7, wherein the solvent includes at least one of organic and inorganic solvents including water, phosphate buffered saline (PBS), glycerol, ethanol, methanol, acetone, hexane, and benzene.

9. The method of claim 1, wherein the graphene layer includes graphene oxide or reduced graphene oxide.

10. The method of claim 9, further comprising
converting the graphene oxide into reduced graphene oxide, when the graphene layer includes the graphene oxide.

11. The method of claim 1, wherein the substrate includes a plastic, an organic film, silicon, or glass.

12. The method of claim 11, wherein the fine pattern is formed by an injection molding process, a hot embossing process, a nano-imprint process, a casting process, a rolling process, a forging process, and/or a semiconductor process.

13. The method of claim 1, further comprising:
performing a surface treating process on the substrate having the fine pattern.

14. The method of claim 13, wherein the surface treating process includes a plasma-treating process using oxygen and/or carbon fluoride.

15. The method of claim 1, wherein applying the graphene solution comprises: dipping the substrate in the graphene solution.

16. The method of claim 1, further comprising:
placing the substrate into a container.

17. The method of claim 16, wherein the container includes a housing or package surrounding the substrate.

18. The method of claim 1, further comprising:
forming a self-assembled layer on the fine pattern.

19. The method of claim 18, wherein the self-assembled layer is a monolayer.

20. The method of claim 19, wherein the monolayer includes at least one of a thiol group, a silane group, a carboxyl group, a hydroxyl group, a methyl group, a phosphonate group, and an amine group.
